(19) United States
(12) Patent Application Publication
(10) Pub. No.: US 2024/0020656 A1
(43) Pub. Date: Jan. 18, 2024

(54) SYSTEM AND METHOD OF MANAGING WORK ORDERS

(71) Applicant: OnPoint Group, LLC, Perrysburg, OH (US)

(72) Inventors: Kevin Snyder, Perrysburg, OH (US); Chad Albright, Perrysburg, OH (US); Diana Bregman, Perrysburg, OH (US); Ryan Collins, Perrysburg, OH (US)

(21) Appl. No.: 18/353,484

(22) Filed: Jul. 17, 2023

Related U.S. Application Data
(60) Provisional application No. 63/368,561, filed on Jul. 15, 2022.

(51) Int. Cl. G06Q 10/20

(52) U.S. Cl. CPC G06Q 10/20

(57) ABSTRACT

A method of executing a work order includes generating a work order and assigning the work order to a technician, the technician utilizing a user device executing a software application managed by a computing system. A check-in process is conducted wherein the computing system determines whether the technician has satisfied each of one or more check-in conditions. The technician assesses and diagnoses any potential issues or concerns with respect to each of the assets associated with the work order. A check-out process is conducted following completion of the task specified by the work order and/or the technician requesting a second technician engagement at the work site, and includes the computing system determining whether the technician has satisfied each of one or more check-out conditions.

### CROSS-REFERENCE TO RELATED APPLICATION

This patent application claims priority to U.S. Provisional Patent Application Ser. No. 63/368,561, filed on Jul. 15, 2022, the entire disclosure of which is hereby incorporated herein by reference.

### FIELD OF THE INVENTION

A system and method for managing work orders is disclosed, and more particularly, a system and method for coordinating and maintaining consistency in the performance of repair or maintenance work orders for assets managed by a business entity where the work orders are assigned to multiple different affiliate entities.

### BACKGROUND OF THE INVENTION

Businesses that manage assets at customer facilities often face difficulties in effectively managing work orders. These work orders involve tasks such as repairs, maintenance, and servicing of the assets owned or operated by the business entity. To handle these work orders efficiently, the business entity typically assigns them to affiliate entities associated with the business entity and having expertise or certification in servicing the assets managed by the business entity. Each affiliate entity, in turn, assigns the work orders to their qualified technicians for execution.

However, existing methods of managing work orders suffer from several drawbacks. One significant concern is the varying customer requirements and customized procedures that must be followed during the execution of work orders. Certain customers may have specific documentation needs, check-in or check-out procedures, or other customized requirements that must be adhered to for compliance and customer satisfaction. Coordinating and managing these diverse customer demands efficiently can be a challenging task for the business entity when dealing with different affiliate entities.

Another problem arises from the fact that each affiliate entity may employ different technologies or business practices. This disparity in workflows and documentation practices among the affiliates creates inconsistency in the execution of work orders and the recording of tasks performed. Each affiliate may have its unique work processes, documentation templates, or reporting mechanisms, making it difficult for the business entity to maintain consistent relationships and monitor the progress of work orders effectively.

There is, therefore, a need for an improved method of managing work orders and maintaining consistency in their execution, irrespective of varying customer requirements and diverse affiliate practices. The present invention addresses these challenges by providing a novel system and method that streamline the management of work orders, ensuring adherence to customer-specific procedures and promoting consistent execution and documentation practices across multiple affiliates.

### SUMMARY OF THE INVENTION

Concordant and congruous with the present invention, a system and method for managing work orders has surprisingly been discovered.

The invention disclosed herein overcomes the problems associated with existing methods by providing a comprehensive system and method for managing work orders within a business entity that manages assets at customer facilities. The invention offers a solution to the challenges posed by customized customer requirements and differing affiliate practices, ensuring consistency and efficiency in the execution of work orders.

By implementing the present invention, the business entity can seamlessly handle work orders and their associated customer-specific requirements. The system allows for the customization of work order procedures, documentation, check-in/check-out processes, and other tasks, ensuring compliance with individual customer demands. Additionally, the invention facilitates effective communication and coordination between the business entity and its affiliate entities, promoting consistency in workflows, documentation practices, and reporting mechanisms.

In conclusion, the present invention represents a significant advancement in the field of work order management for businesses handling assets at customer facilities. It addresses the existing challenges by providing an innovative system and method that ensures the efficient execution of work orders, compliance with customer requirements, and consistency in workflows and documentation practices across multiple affiliate entities.

According to an embodiment of the present invention, a method of executing a work order comprising the steps of: generating, by a computing system of a first business entity, a work order regarding a task to be performed at a work site with respect to one or more assets disposed thereat; assigning the work order to a technician, the technician utilizing a first user device executing a software application managed by the computing system; conducting a check-in process regarding confirming an arrival of the technician and the first user device thereof at or adjacent the work site during a first technician engagement at the work site, the check-in process including the computing system determining whether the technician has satisfied each of one or more check-in conditions, wherein each of the check-in conditions being satisfied includes a check-in communication being sent from the first user device of the technician to the computing system during execution of the software application; assessing and diagnosing, by the technician, any potential issues or concerns with respect to each of the one or more assets associated with the work order; and conducting a check-out process regarding the technician completing the task specified by the work order and/or the technician requesting a second technician engagement at the work site, the check-out process including the computing system determining whether the technician has satisfied each of one or more check-out conditions, wherein each of the check-out conditions being satisfied includes a check-out communication being sent from the first user device of the technician to the computing system during execution of the software application.

### BRIEF DESCRIPTION OF THE DRAWINGS

The above, as well as other advantages of the present invention will become readily apparent to those skilled in the art from the following detailed description of a preferred embodiment when considered in the light of the accompanying drawings.

FIG. 1 illustrates an enterprise system and environment thereof for engaging with an affiliate user during navigation of a work order management platform, in accordance with one embodiment of the present invention.

FIG. 2 is a flow chart summarizing a work flow of assigning and carrying out a work order according to the present invention.

FIG. 3 is an interface of the work order management platform as may be found on a display of a user device when utilizing a web browser executed thereon.

FIG. 4 is an interface of the work order management platform as may be found on a display of a user device when utilizing a dedicated software application executed thereon.

FIGS. 5-7 are exemplary interfaces of the work order management platform following the initiation of a work order.

### DETAILED DESCRIPTION OF EXEMPLARY

### Embodiments of the Invention

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

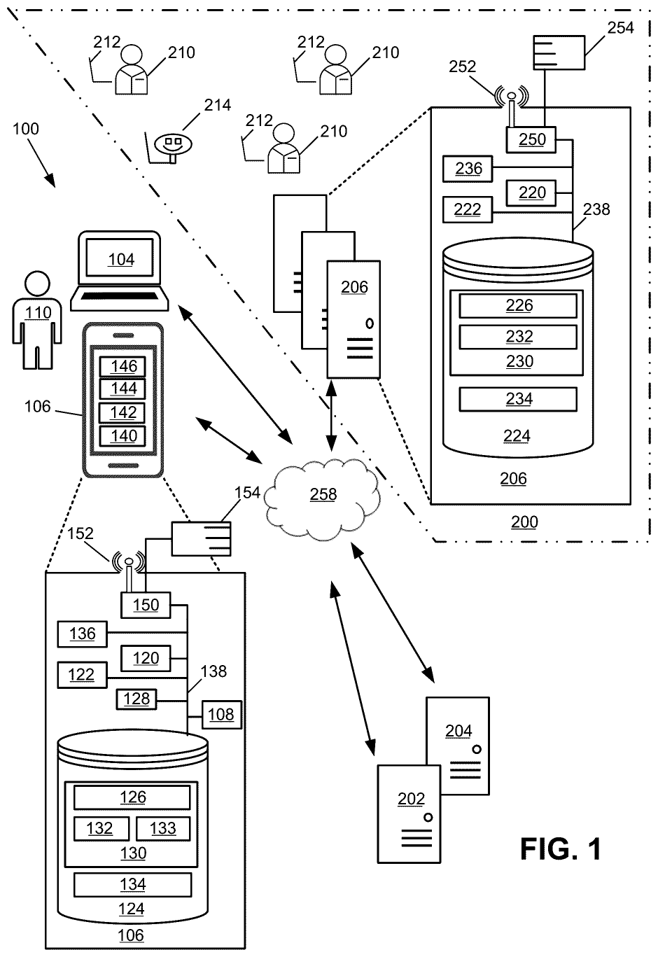

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated applications 132, 133 are represented as particular examples. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110 in accordance with the system and method of the present invention. In some examples, the enterprise system 200 offers products, and in other examples, the enterprise system 200 offers services. Use of “service(s)” or “product(s)” thus relates to either or both in these descriptions. In non-limiting examples, services and products include information services and products, custom services and products, predefined or pre-offered services and products, consulting services and products, or advising services and products.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, online customer service assistants available to users 110, advisors, project managers, sales team members, technicians, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1. As used hereinafter, it is assumed that references to the enterprise system 200 performing an action related to the collection, transfer, or analysis of data is referring to an action being taken by the appropriate components of the computing system 206 of the enterprise system 200 as described herein. Similarly, references to such actions being performed by the computing devices 104, 106 or the external systems 202, 204 should be assumed to be performed by corresponding components thereof.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent third party sources of data associated with a specific accounts, such as repositories of such data or entities responsible for the collection of such data.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The present invention relates to a system and method of managing work orders associated with performing maintenance and/or repair with respect to a specified work site. The system and method includes the use of a software application 132 managed by the enterprise system 200, and more specifically, managed by the computing system 206 of the enterprise system 200. The software application 132 may be executable on any of the described user devices 104, 106 or agent devices 212 and provides a graphical interface for each user 110, 210 of the software application 132 to interact with data associated with at least one work order managed by the enterprise system 200 before and after the completion of the work order.

The present invention is described hereinafter with reference to navigation of the software application 132, but it should be understood that the present invention is not limited to the use of a dedicated software application 132 executable on one of the described user devices 104, 106 or agent devices 212 in viewing or organizing the work order related data described herein. Instead, the features described herein may similarly be accessed via a corresponding website accessible via a web browsing application executable on any of the described user devices 104, 106 or agent devices 212, wherein such a website may include the same or similar interfaces for accomplishing the same tasks as described with respect to the application 132. It is generally assumed hereinafter that the same features of the present invention may be accessible via use of the website accessible via the browser application or the direct use of the software application 132. It should also be generally understood that the website and the software application 132 may generally include the display of the same data regarding the work orders and the interactions therewith, but may in some circumstances include a different arrangement of such data to best accommodate the configuration of the corresponding user device 104, 106, such as accommodating a specific screen configuration or a specific user input method.

The methods disclosed herein also include references to the computing system 206 responsible for communicating data necessary for the operation of the software application 132 storing data or files relating to a facility, customer, organization, technician, and/or work order to the storage device 224 thereof. As utilized herein, the storage device 224 of the computing system 206 is not limited to a storage device exclusively managed by the enterprise system 200, and may instead refer to a third-party data storage device in communication with the computing system 206, or any other form of storage device 224 associated with and accessible by the computing system 206. That is, as opposed to storing all associated data to a storage medium maintained directly by the enterprise system 200, the enterprise system 200 may utilize an external storage medium managed by a third-party entity for storing such data. The application 132 according to the present invention may accordingly utilize cloud-based functions to transfer data between the computing system 206 and any corresponding third-party entity, such as one of the described external systems 202, 204, during navigation of the software application 132 for sending and/or retrieving the desired data at the desired instance. It is accordingly not critical to the present invention that the acquired data be stored to a specific storage device or location, so long as the application 132 routes the desired data to the corresponding user for display thereto in accordance with the novel features of the present invention.

As used herein, each corresponding work site may refer to a bounded area (parcel) of real property, a contiguous set of parcels of real property, an identifiable building or structure found on one or more parcels of real property, a unit or subunit of a building or structure, or a campus/facility comprising a plurality of contiguous buildings, structures, or the like, as non-limiting examples. Each work site may include geo-positional data associated therewith, such as utilizing the longitude and latitude coordinates of the geographic coordinate system (CGS) in identifying the geographic position of the work site. Each work site may include a street address that is associated with the geo-positional data to allow the work site to be discoverable via the GPS-based navigation methods typical of smart devices such as any of the disclosed user devices 104, 106 or agent devices 212. Each work site may be described by a set of nominal coordinates corresponding to a point position within the respective work site as established by the street address of the work site. For example, a work site corresponding to a parcel of property covering a two-dimensional area may include a nominal point position at a two-dimensional (longitude and latitude) center of the area bound by the perimeter of the work site, and the coordinates of this nominal point position of the work site may be utilized in identifying the geographic position of the work site. The nominal point position may correspond to any position within the work site, as desired, in addition to the example of the center point.

Each work site is associated with a customer of the enterprise system 200 that has requested the services of the enterprise system 200 in carrying out a work order in accordance with the present disclosure. The customer may refer to the person or entity owning, managing, or otherwise having authority over the corresponding work site, or to an authorized agent of such a person or entity having the authority to act in such a capacity.

The enterprise system 200 may be responsible for the management of one or more assets at each of the different work sites at which a work order may be carried out. Such assets may refer to any parts, equipment, structures, installations, or the like that are in any way maintained or monitored by the enterprise system 200. The enterprise system 200 may also be associated with one or more affiliate organizations that aid in carrying out the work orders generated by the software application 132, wherein such work orders may relate to tasks to be performed with respect to at least one of the assets found at the corresponding work site and managed/monitored/maintained by the enterprise system 200. That is, the enterprise system 200 may be representative of an entity that contracts with or otherwise employs one or more third-party entities to carry out the work orders that originate from the enterprise system 200, via the request of a customer of the enterprise system 200. Each affiliate organization may in turn employ or contract work to at least one technician capable of carrying out the tasks specified in a corresponding work order, if not a plurality of such technicians. Such technicians may be assumed to have sufficient training and/or certification in performing tasks with respect to the assets managed by the enterprise system 200. Each affiliate organization may further employ or contract work to at least one administrator or manager responsible for carrying out tasks associated with use of the application 132, wherein such an administrator or manager does not directly technically engage with the work site when performing the task specified by the work order, but instead delegates such a task to a specified technician and/or performs administrative or management related tasks related to carrying out the work order. However, it should also be understood that each affiliate organization may include a single person or any grouping of multiple persons carrying out any combination of the described technical and administrative tasks, depending on the circumstances of each individual affiliate organization, hence the present invention is not limited to requiring the use of distinct administrators and technicians when completing the process of assigning and completing a work order. For example, it is conceivable that an administrator or manager also having appropriate technical training and certification, or a technician having administrative or management authority with regards to the affiliate organization, may be capable of carrying out any and all of the steps stated as being associated with one of the affiliate organizations when utilizing the application 132.

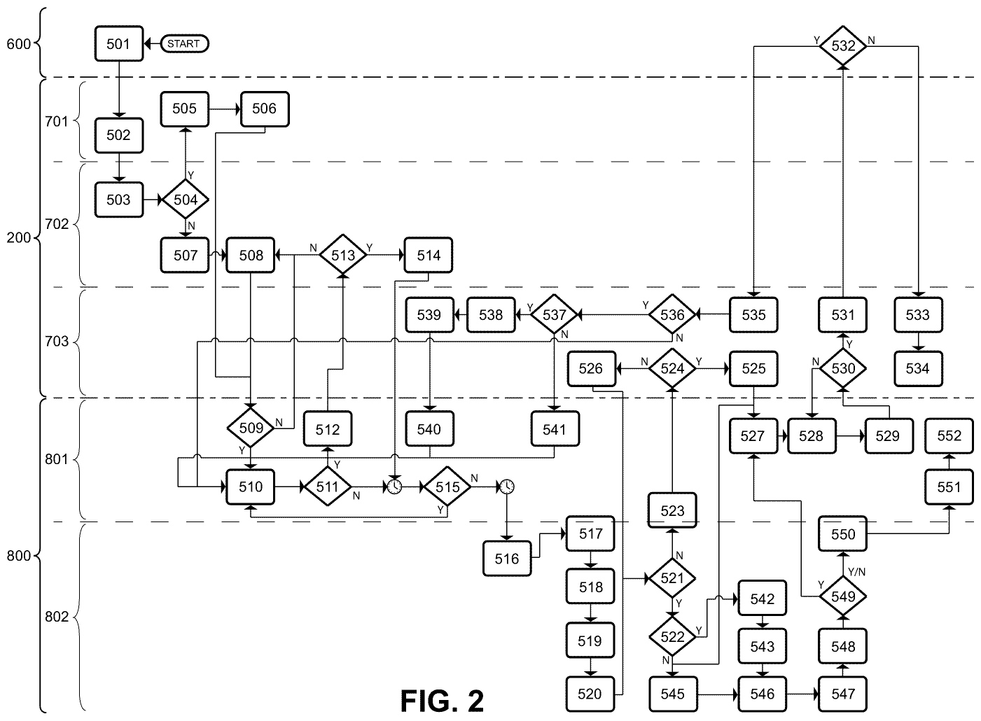

As utilized hereinafter, each agent 210 of the enterprise system 200 may refer to any employee, contractor, or the like otherwise performing tasks on the behalf of the enterprise system 200 in accordance with the presently disclosed system and method. Each agent 210 of the enterprise system 200 may have appropriate permissions to access the data related to the status of any work order managed by the software application 132, and/or to assign or retract the assignment of each work order to one or more technicians associated with one of the corresponding affiliate organizations. The agents 210 of the enterprise system 200 may include at least one agent 702 (FIG. 2) performing dispatching duties and at least one agent 703 performing account management duties with respect to the corresponding work site and/or customer, although any distribution of duties may be utilized while remaining within the scope of the present invention, including the use of any number and distribution of agents 210 performing the described tasks or the use of automated processes in performing those tasks indicated as being performed by one of the agents 210, as elaborated on hereinafter.

The application 132 may be accessed and utilized by any number of different parties when creating, assigning, carrying out, and processing a work order. Each technician and/or administrator associated with one of the affiliate organizations may be considered one of the users 110 of the application 132 as designated hereinafter, and may utilize any of the described user devices 104, 106 when accessing and interacting with the graphical interface of the application 132. Each agent 210 of the enterprise system 200 may similarly access the software application 132 via an appropriate agent device 212, or may have direct access to the computing system 206 in managing any aspects of the operation of the application 132 as described herein.

Referring now to FIG. 2, a flow chart 1000 showing a representative method of operation of the present computing system 206 and associated software application 132 according to an embodiment of the present invention is disclosed. The flow chart 1000 includes a division of the steps performed by various parties/systems associated with operation of the computing system 206 and the application 132 accordingly to one representative example. The parties include a customer 600 requesting that a work order be created for carrying out at a task at a work site associated with the customer 600, the enterprise system 200, and a representative affiliate organization 800 that has a relationship with the enterprise system 200 regarding the performance of work orders assigned by the enterprise system 200 to the affiliate 800.

The enterprise system 200 is shown as being divisible into steps performed by an automated system 701, a dispatcher agent 702, and an account managing agent 703. The affiliate 800 is shown as being divisible into steps performed by an administrator 801 and a technician 802. Steps that may be performed by either of the administrator 801 or the technician 802, or that require communication directly therebetween, are represented as spanning the broken line indicating the division in the flow chart 1000 between the administrator 801 and the technician 802. However, as explained above, substantially any steps described hereinafter as being performed by the enterprise system 200 may refer to steps performed by any qualified representative thereof and/or any combination of representatives thereof, hence the present system and method is therefore not limited to the division of steps among the automated system 701, the dispatcher agent 702, and the account managing agent 703 of FIG. 2. Similarly, substantially any steps described hereinafter as being performed by the affiliate 800 may refer to steps performed by any qualified representative thereof and/or any combination of representatives thereof, hence the present system and method is not limited to the division of steps between the administrator 801 and the technician 802. Any of the steps indicated as being performed by the enterprise system 200 may accordingly be performed by any of the automated system 701, the dispatcher agent 702, and/or the account managing agent 703 while remaining within the scope of the present invention, as circumstances may warrant. Similarly, any of the steps indicated as being performed by the affiliate 800 may accordingly be performed by either of the administrator 801 or the technician 802 while remaining within the scope of the present invention, as circumstances may warrant.

The method according to the flow chart 100 occurs as follows. The method begins with step 501, where the customer 600 of the enterprise system 200 submits details of a work request. The customer 600 can use various communication methods, such as an online form, email, phone call, or a dedicated customer portal within the software application 132, to submit the request. Once the request is received, a step 502 involves the computing system 206, via the automated system 701 thereof, creating a work order case related to the work request. This work order case acts as a container for managing all relevant information and activities associated with the customer request. The work order case may be representative of a file location wherein all data and/or files associated with the corresponding work order are stored and organized. The work order cases generated by the computing system 206 may be stored to the storage device 224 of the computing system 206 where each work order case is individually accessible during navigation of the application 132 on an associated user device 104, 106. Following creation of the work order case, a step 503 involves a dispatcher 702 of the enterprise system 200 confirming the details of the work request with the customer 600. The confirmation is conducted using any appropriate communication method, such as phone, email, or messaging, to ensure accurate understanding of the requirements and to clarify any ambiguities.

Completion of the steps 501, 502, 503 may include the establishment of a customer approved not-to-exceed (NTE) amount based on the labor and/or parts expected to be necessary in completing the work order. The customer NTE amount may include a combination of any fees charged by the enterprise system 200 and any fees charged by the affiliate 800 in completing the corresponding work order. The customer NTE amount may be stored to the corresponding work order case and may thus be accessible during navigation of the application 132.

Once the necessary details of the work order request are confirmed, at a step 504 the computing system 206 makes a determination on whether to automatically generate and assign the work order to an affiliate 800 (indicated as the “yes” determination in FIG. 2), or whether to have the generation and assignment of the work order performed by the dispatcher 702 through interaction with the computing system 206 (indicated as the “no” determination in FIG. 2). The determination made at step 504 may be based on whether or not the computing system 206 is operating according to an automatic assignment process (corresponding to “yes”) or a manual assignment process (corresponding to “no”).

When the automatic assignment process is utilized, a step 505 includes the computing system 206 automatically generating a work order according to any confirmed data acquired and recorded during any of steps 501, 502, 503. The work order contains specific details regarding the task to be performed, customer information, and any additional instructions or materials required. The work order is associated with the corresponding work order case and is accessible when accessing the corresponding work order case during navigation of the software application 132. In a step 506, the computing system 206 generates an assignment request communication to be sent to the administrator 801 of a corresponding affiliate 800 regarding whether to accept or reject the work order generated in step 505. A determination of which affiliate 800 among a plurality of possible affiliates 800 having a relationship with the enterprise system 200 is to receive the initial assignment request communication may be based on various factors such as the availability, proximity, skills, and workload of each of the affiliates 800, as known to the computing system 206 via management of the application 132 and the associated work orders. Configurable parameters or business rules may be utilized to determine the assignment logic of the computing system 206.

When the manual assignment process is utilized, a step 507 includes the dispatcher 702 creating a work order via interaction with one or the software application 132 or the computing system 206 managing the software application 132. The work order is similarly associated with the corresponding work order case as described with reference to the automatic assignment process. In a step 508, the dispatcher 702 manually selects the affiliate 800 to utilize among a plurality of affiliates, wherein such a determination may be performed via any desired parameters or business rules. The step 508 includes the sending of an assignment request communication to the selected affiliate 800 regarding whether to accept or reject the work order generated in step 507.

Each of steps 506 (automatic assignment) and 508 (manual assignment) lead to a step 509 wherein the administrator 801 of the selected affiliate 800 makes a determination whether to accept the assignment request (indicated as the “yes” determination in FIG. 2) or reject the assignment request (indicated as the “no” determination in FIG. 2). The receipt of the assignment request communication by the administrator 801 may also include a notification being sent to the user device 104, 106 of the administrator 801, such as by push-notification, to quickly alert the administrator 801 and the corresponding affiliate 800 of the request and the need for a timely response. The step 509 may include a prompt being displayed on the graphical display of the corresponding user device 104, 106 on which the application 132 is executed during the step 509, wherein the prompt requests that the selected affiliate 800 accept or reject the assignment request. If no response is provided, the “no” determination in FIG. 2 may alternatively be representative of the assignment request timing out according to a prescribed time limit for replying to the assignment request communication having passed without a reply.

When the assignment request is rejected or times out, FIG. 2 illustrates the progression from the step 509 back to the step 508 where the dispatcher 702 of the enterprise system 200 selects another affiliate 800 among the plurality of associated affiliates 800 to contact next for once again performing the determination at step 509. FIG. 2 accordingly illustrates the automatic assignment process as converting to a manual assignment process upon a rejection or timing out of the initial request. However, FIG. 2 is not considered limiting, as the process may instead include a progression from the step 509 back to the step 506 corresponding to the automatic selection of the next affiliate 800 to which to communicate the assignment request communication, wherein such a selection may once again be determined by predefined rules follows each subsequent rejection or time out in step 509.

At the conclusion of the step 506 or the conclusion of the step 508, there may be an established affiliate NTE amount associated with the work order that is accessible when accessing the corresponding work order case during navigation of the application 132. The affiliate NTE amount may be an amount less than the customer NTE amount due to the additional fees that may be associated with the management of the work site and corresponding assets by the enterprise system 200 that may also be included in the customer NTE amount. The affiliate NTE amount accordingly corresponds to the fees associated only with the execution of the work order in accordance with the tasks performed by the affiliate 800 and all associated administrators 801 and/or technicians 802. The affiliate NTE amount may be based upon factors such as the expected parts, labor, number of technicians, time to be expended, etc.

The steps 506, 508, and 509 may be repeated in the necessary order as many times as necessary until one of the selected affiliates 800 accepts the assignment request at the step 509, thereby progressing the method to a step 510 where the affiliate administrator 801 assigns the work order to one or more technicians 802 of the affiliate 800. The step 510 may include the administrator 801 selecting one or more of the technicians 802 of the affiliate 800 from a list of the technicians 802 to assign the work order to the corresponding one or more of the technicians 802. The step 510 may further include the administrator 801 setting an initial estimated time of arrival (ETA) for the one or more technicians 802 of the affiliate 800 having been assigned the work order to arrive at the corresponding work site to continue the process of completing the assigned work order. The step 510 may be performed by the administrator 801 during navigation of the application 132, and each of the technician assignment and the initial ETA may be stored to the work order case to allow for access thereto when accessing the work order case during navigation of the application 132.

In a step 511, a determination is made regarding whether the technician ETA established in step 510 falls outside of a designated acceptable work window that is specified by the customer 600 and/or the enterprise system 200 during the steps 501, 502, 503, wherein in FIG. 2 a “yes” determination indicates that the ETA is outside of the approved work window while the “no” determination indicates that the ETA is within the approved work window (and especially before the end of the term thereof). When the ETA is outside of the approved work window (yes), the method progresses to a step 512 wherein the administrator 801 of the affiliate 800 contacts the dispatcher 702 of the enterprise system 200 to report that the selected ETA falls outside of the authorized work window and to request permission to utilize the ETA falling outside of the authorized work window. Such a request may be made via an interaction with the application 132 during execution on one of the user devices 104, 106 or may occur as a result of an alternative communication method, such as a phone call, email, or other messaging method. In a step 513, a determination is made by the dispatcher 702 of the enterprise system 200 whether to approve the request to allow the selected ETA to fall outside of (after) the customer-determined work window (indicated as the “yes” selection in FIG. 2) or to reject the request for the selected ETA (indicated as the “no” selection in FIG. 2). When the determination in step 513 includes approval of the request (yes), a step 514 occurs wherein the dispatcher 702 of the enterprise system 200 enters the approved ETA as the updated ETA to be utilized by the corresponding one or more technicians 802 when initially arriving at the work site. The updated ETA may be associated with the work order case and may thus be accessible when accessing the corresponding work order case during navigation of the application 132. In contrast, when the determination in step 513 includes a rejection of the request (no), the method returns back to the step 508 where the dispatcher 702 of the enterprise system 200 selects one of the affiliates 800 among the plurality of associated affiliates 800 to contact next for once again performing the determination at step 509 regarding the acceptance of the assignment of step 508. Alternatively, the rejection of the request at step 513 may include the method redirecting back to the step 506 rather than the step 508, as desired.

As can be seen by the clock symbol in FIG. 2, a “no” determination with respect to step 511 or a “yes” determination with respect to step 513 leads to the passage of time wherein the end of the approved work window approaches and a determination must be made by the administrator 801 of the affiliate 800 at a step 515 whether to change the previously established ETA (indicated as a “yes” determination in FIG. 2) or to progress with the previously established ETA (indicated as a “no” determination in FIG. 2). The “yes” determination with respect to step 515 results in the method returning back to the step 510 wherein the administrator 801 of the affiliate 800 either selects the new ETA for the already selected one or more technicians 802, or assigns one or more new technicians 802 to aid in fulfilling the work order within the established work window, before once again progressing through step 511 and the subsequent passage of additional time thereafter. A “no” determination at step 515 indicates that no further change to the ETA is required, hence the method is able to progress onward to a step 516 wherein the corresponding technician 802 travels to the work site designated by the corresponding work order following the appropriate passage of time, as once again indicated by the clock symbol in FIG. 2.

Once a work order has been assigned to a technician 802, the technician 802 is then provided the necessary permissions and access to view and, in some circumstances, edit any of the work order related data, files, or content that is described as being stored to or otherwise associated with the corresponding work order case. As explain hereinafter, each technician 802 may be able to view and sort any pending or active work orders assigned to the technician 802 during navigation of the application 132, and may select a desired one of the work order cases to review and/or edit any content associated therewith. A work order may be deemed active following the establishment of the initial ETA in step 510, and may continue to be active until the completion of the work order. The application 132 may include the display of the progress of the work order once attaining active status, such as showing whether each associated step of the disclosed method has been completed in sequence by the affiliate 800 during execution of the method. It is assumed hereinafter that any modifications or additions to the work order case, as may occur during the process of carrying out the work order by the affiliate 800, may include the corresponding administrator 801 or technician 802 accessing the corresponding work order case during navigation of the application 132, wherein the access to the work order case provides options to the administrator 801 and/or the technician 802 regarding the execution of additional steps of the present method as set forth hereinafter.

The step 516 may occur with the location tracking services of the user device 104, 106 executing the application 132 activated, such as allowing the application 132 to monitor the GPS position of the user device 104, 106 during the process of traveling to the work site at a time corresponding to the most recently established technician ETA. The application 132 may also optionally include a GPS-based navigation feature for guiding the technician 802 to the appropriate location corresponding to the work site at or around the established ETA, or may include access to an external system providing a similar functionality. In any event, the step 516 occurring with the location tracking services of the user device 104, 106 activated includes the application 132 having access to the instantaneous geographic position of the technician 802 throughout the step 516 to continuously determine a distance of the technician 802 from the corresponding work site.

Once the technician 802 is approaching or has reached the work site during the step 516, a step 517 occurs wherein the corresponding technician 802 is able to check-in at or adjacent the geographic position of the work site to establish and confirm the presence of the technician 802 at the work site at a specific time, such as within a specified time frame before or after the previously established ETA of technician arrival. The check-in step 517 may occur according to one of two different check-in processes.

According to a first process of carrying out the step 517, the application 132 is executed on the user device 104, 106 of the technician 802 with the ability to track the geographic position of the user device 104, 106 activated such that a distance present between the instantaneous position of the user device 104, 106 and the position of the work site is known by the application 132 via appropriate access to the location tracking services of the user device 104, 106 and the known position of the work site as established when generating the work order during steps 501, 502, 503. The application 132 may be configured to only allow the technician 802 to check-in to the work site via the application 132 when the application 132 has determined that the distance present between the technician 802 and the work site is equal to or less than a predetermined threshold value, such as 0.2 miles, as one non-limiting example. In some embodiments, the technician 802 does not need to actively choose to check-in when within the threshold distance, but may instead be automatically checked-in via the application 132 when the determined relative distance meets or is below the threshold distance. In other embodiments, the technician 802 may select an option as displayed on a graphical interface of the user device 104, 106 executing the application 132 to actively choose to complete the check-in process when within the threshold distance of the work site. The check-in process may include the user device 104, 106 of the technician 802 communicating with the computing system 206 of the enterprise system 200 to inform the computing system 206 that the technician 802 has arrived at (or adjacent) the work site and is ready to proceed with any further tasks associated with completing the work order.

According to a second process of carrying out the step 517, the administrator 801 and/or the technician 802 may initiate a manual check-in process that does not necessarily rely upon the utilization of the location tracking services of the user device 104, 106. Such a manual check-in process may be required where internet access, cellular coverage, GPS access, or the like is difficult to achieve during the step 516, or where such services are for any reason otherwise unavailable in determining the instantaneous position of the user device 104, 106 relative to the work site. The manual check-in process may include the technician 802 and/or the administrator 801 selecting the work order case in question via navigation of the application 132 to select an option to manually check-in when the technician 802 is at or adjacent the work site and is otherwise unable to automatically check-in. For example, the beginning of the servicing of the work site via the beginning of travel at step 516 may include the application 132 displaying the data associated with the corresponding work order case on the user device 104, 106 for aiding the technician 802 in understanding the work to be completed as well as the position of the technician 802 relative to the work site, such as displaying a map showing each of the positions of the user device 104, 106 of the technician 802 and the work site, and potentially a route to most efficiently travel to the work site. The application 132 may display an option to manually check-in the technician 802 upon arrival thereat, such as displaying a “check-in” button or graphic interactive area on the display of the user device 104, 106 when accessing and viewing the work order case following a selection thereof during navigation of the application 132.

The manual check-in process may include an additional step wherein the technician 802 is immediately prompted by the application 132 to take a photographic image of the work site to establish the actual presence of the technician 802 thereat. That is, the selection to check-in the technician 802, whether initiated by the technician 802 or the administrator 801, may result in a redirection of the user device 104, 106 of the technician 802 to a camera feature thereof for taking the photographic image of a corresponding feature of the work site, such as one of the assets in need of repair, replacement, maintenance, or the like. The check-in process is not considered complete until the technician 802 has taken and uploaded the necessary photographic image to the computing system 206 for potential future review via navigation of the application 132 and access to the corresponding work order case.

Additional steps may be required to complete either of the disclosed check-in processes where such additional steps are required by the customer 600. For example, the customer 600 may request that another form of communication, such as a phone call from the technician 802 to the customer 600 upon arrival at the work site, is necessary and must be completed for the check-in process to be considered to have occurred. The application 132 may accordingly include the display of any data related to carrying out any such additional steps when completing the check-in process via access to the work order case, or may even be configured to redirect the user device 104, 106 of the technician 802 to an associated feature of the user device 104, 106 for carrying out the necessary communications for completing the check-in process upon a corresponding interaction of the technician 802 with the user device 104, 106. For example, the application 132 may display a graphic interactive area in the form of a button or the like that, when interacted with by the technician 802, redirects the user device 104, 106 to utilize a communication method thereof, such as automatically redirecting the user device 104, 106 to call a phone number to complete a call prescribed by the customer 600 as necessary to complete the check-in process.

Regardless of whether the check-in process is automated, manual, or a combination thereof, the computing system 206 is configured to only change the status of the technician 802 to being checked-in at the work site, as displayed via the application 132 with respect to a status of the completion of the work order, when one or more corresponding check-in conditions have been satisfied by the technician 802 to establish the physical location of the user device 104, 106 of the technician 802 at the work site. Each of the check-in conditions may be established as being met following a communication from the user device 104, 106 to the computing system 206 with the corresponding communication including data relating to the presence of the technician 802 at the work site. In the preceding examples, the check-in conditions being satisfied may include the user device 104, 106 communicating a geographic position thereof to the computing system 206 and the computing system 206 determining that the communicated position is within the threshold distance of the work site or the user device 104, 106 uploading an image or other content relating to data collected at the work site during a physical interaction therewith to the computing system 206 following the use of the camera feature of the user device 104, 106, among the other conditions stated herein. The technician 802 being checked-in may include the computing system 206 determining that any number or combination of such check-in conditions is satisfied before establishing the technician 802 as checked-in at the work site, as desired.

Once the check-in process is complete according to step 517, the technician 802 then proceeds to a step 518 wherein the technician physically locates the assets associated with the work order at or on the work site and then a step 519 wherein the technician 802 assesses and diagnoses any potential issues or concerns with respect to each of the assets associated with the work order. Next, in a step 520, the technician 802 utilizes the camera feature of the corresponding user device 104, 106 to take and then upload to the computing system 206, via the application 132, at least one photographic image of the work site, and especially the relevant asset(s) thereof, in a “before” configuration corresponding to an appearance of the work site and the associated asset(s) thereof prior to the completion of the tasks associated with the work order. The step 520 accordingly preserves a record regarding the condition of any such assets prior to the technician 802 carrying out any processes intended to alter the condition of such assets thereafter. The step 520 may include the selection of the corresponding work order case followed by the selection of a button or graphic interactive area corresponding to the use of the camera feature for generating and then uploading the appropriate image during use of the application 132. Each of the “before” images is stored to the associated work order case for access thereto during navigation of the application 132.

Following the uploading of the “before” photographic images of step 520, the method proceeds to a step 521 wherein a determination is made whether the work order can be completed without the technician 802 exceeding the affiliate NTE amount established prior to the acceptance of the assignment in steps 509 and 510. That is, the technician 802 determines whether additional labor and/or additional parts are required beyond that already budgeted within the affiliate NTE amount in order to complete the work order, wherein such a determination occurs following review of the work site and corresponding assets during the steps 518, 519, 520. According to step 521, a “yes” determination indicates that the technician 802 believes that the work order can be completed within the budgeted affiliate NTE amount and the technician 802 is then able to proceed to make another determination according to step 522. In contrast, a “no” determination according to step 521 causes the method to progress to a step 523 where the technician 802, the administrator 801, or a combination thereof prepares a request of the enterprise system 200 to increase the previously agreed upon affiliate NTE amount in accordance with the determination of the technician 802 in step 521 that additional parts and/or labor are needed beyond that established according to the original affiliate NTE amount.

The step 523 may include the application 132 executed on the user device 104, 106 displaying an option to increase the affiliate NTE amount following the completion of the check-in process of the technician 802 according to step 517, wherein such an option may be selected during access to the corresponding work order case. Upon making such a selection, the application 132 may generate a template wherein the technician 802 is able to populate various fields relating to the scope of the work to be completed, the number of technicians needed, the number of hours of labor required, the hourly rate at which the work would be completed, and any additional parts or materials expected to be necessary to complete the work order. The parts may be selected from a previously existing list or may be manually entered, as necessary. Upon entry of all necessary data, the technician 802 submits the NTE increase and a corresponding NTE request communication is sent from the user device 104, 106 of the technician 802 to the computing system 206 for a determination to be made by the account managing agent 703 of the enterprise system 200 according to a step 524.

The step 524 includes the account managing agent 703 determining whether a combination of the newly submitted affiliate NTE amount and any additional fees charged by the enterprise system 200 regarding the completion of the work order (such as a management fee) exceeds the customer NTE amount as established during the steps 501, 502, 503. A determination of “yes” according to step 524 indicates that the customer NTE has been exceeded and that a request for a formal quote according to a step 525 is necessary, whereas a determination of “no” according to step 524 indicates that the customer NTE has not been exceeded, and that a formal quote need not be generated. The determination of “no” in step 524 leads to a step 526 wherein the account managing agent 703 of the enterprise system 200 approves the NTE increase and therefore establishes a new, revised affiliate NTE amount. The step 526 may include the account managing agent 703 accessing the application 132 or the computing system 206 directly to approve of the request and to cause the computing system 206 to update the revised affiliate NTE amount, wherein the revised affiliate NTE amount is able to be accessed by the technician 802 when accessing the corresponding work order case during navigation of the application 132. The method then returns to the step 521 where it is once again assessed whether all necessary labor and parts are available.

The step 525, which follows the determination of “yes” in step 524, may include the account managing agent 703 sending a communication to the technician 802, via the computing system 206 and/or the application 132, indicating that a formal quote template has been generated that must be filled out by the technician 802 to form a formal quote. Once such a communication is received by the user device 104, 106 of the technician 802, the application 132 prompts the technician 802 in a step 527 to provide data relating to the generating of the formal quote. In a step 528, the technician 802 populates the necessary fields of the quote template for establishing the formal quote, including entering data regarding the necessary labor, parts, hourly rate, time, equipment needed, rental costs, etc. regarding the new or increased costs corresponding to the NTE increase, that can then be communicated digitally by the computing system 206. Once all necessary information is entered and the quote template is submitted according to step 528, the method may optionally include a step 529 where the technician 802 uploads and/or attaches, via the application 132, any necessary additional documentation regarding the formal quote. For example, a photographic image of the asset in need of attention may be attached to the formal quote as further documentation thereof, or any type or form of file including data relating to the formal quote, the asset, and/or the work site. All such additional documentation may be uploaded via the application 132 and may be stored to and accessible during access to the corresponding work order case.

Following the steps 528, 529, the method then proceeds to a determination at a step 530 where the account managing agent 703 of the enterprise system 200 determines whether the formal quote (and optionally the additional documentation submitted therewith) established in the step 528 (and optionally the step 529) is acceptable, corresponding to the “yes” determination in FIG. 2, or whether the formal quote and optional documentation is unacceptable, corresponding to the “no” determination in FIG. 2. When the “no” determination is made in the step 530, the method returns back to the step 528 where the technician 802 is once again prompted to provide the data regarding the formal quote, which presumably includes a modification of the formal quote to result in the eventual acceptance thereof in the step 530 following as many iterations of steps 528, 529, and 530 as needed to arrive at an agreement.

Once the formal quote is accepted in step 530 (yes), the method proceeds to a step 531 wherein the account managing agent 703 of the enterprise system 200 communicates with the customer 600 regarding the newly proposed formal quote and the corresponding increase in the affiliate NTE amount for completing the work order. The step 531 may occur via any suitable communication method and leads to a determination by the customer 600 in a step 532 whether to approve the increased NTE (“yes” in FIG. 2) or reject the increased NTE (“no” in FIG. 2). If rejected (no), FIG. 2 shows the method as progressing to steps 533 and 534, as performed by the account managing agent 703 of the enterprise system 200. The step 533 may correspond to a communication to the technician 802 that the work order has been deemed completed via the rejection of the quote and increased NTE, while the step 534 may correspond to the corresponding work order case being closed. However, the method may alternatively include a return to a previous step, such as step 524 or 528, to result in the completion of a new quote that may be subsequently approved by the customer 600.

When the customer 600 approves the quote at step 532 (yes), the method progresses to a step 535 where the account managing agent 703 creates a purchase order relating to any parts established as necessary by the formal quote. The step 535 may also include the account managing agent 703 modifying the corresponding work order to reflect any updates in accordance with the modified or new scope of labor specified in the formal quote. The purchase order and/or modified work order are configured to be viewable and accessible during navigation of the application 132 by the technician 802 and access to the corresponding work order case.

Following step 535, a step 536 occurs wherein a determination is made by the account managing agent 703 regarding whether parts must be ordered/purchased to complete the work order in accordance with the purchase order of step 535. A determination of “no” in FIG. 2 for step 536 corresponds to there being no need to attain additional parts, hence the method returns back to the step 509 where the technician 802 accepts or rejects the modified work order, thereby beginning the process of starting the modified work order. That is, the “no” determination may result in an assignment request being sent to the technician 802 in accordance with the newly modified work order.

When the determination of “yes” is made in FIG. 2 with respect to step 536, the method proceeds to a step 537 wherein it is determined whether the enterprise system 200 will attain the necessary parts corresponding to step 536. The “yes” determination for step 537 leads to the enterprise system 200 purchasing the necessary parts in a step 538. Following step 538, a step 539 includes the account managing agent 703 entering data to the computing system 206 regarding an updated expected parts delivery date, which may be viewable by the assigned technician 802 during navigation of the application 132 and access to the corresponding work order case. That is, the expected parts delivery data may be communicated to or otherwise monitored by the technician 802 to aid in determining a priority or timing of completing various work orders associated with the enterprise system 200. In a step 540, the administrator 801 and/or technician 802 of the affiliate 800 receives the necessary parts and the method then proceeds back to the step 510 where the technician 802 establishes an ETA regarding the modified work order. The step 540 may include the administrator 801 and/or technician 802 utilizing the application 132 to indicate that all necessary parts have been received, thereby changing a status of the work order from requiring parts to be delivered to being ready for re-dispatch, as may be communicated via access to the corresponding work order case. Alternatively, a determination of “no” for step 537 results in the progression to a step 541 where the administrator 801 of the affiliate 800 orders and procures the parts relating to the modified work order and/or purchase order, and the step 510 occurs once again following receipt of such parts.

Referring back to step 522, a determination is made by the technician 802 whether the technician 802 has the necessary parts in hand for completing the work order and/or whether the necessary parts can be locally procured absent delay. A “yes” determination for step 522 results in the method progressing to a step 542 where the technician 802 performs the work specified by the work order, which may include the maintenance or repair of at least one asset managed by the enterprise system 200 and located at the work site. A step 543 following the step 542 includes the technician 802 testing the at least one asset and/or a cleaning of the work site and/or the at least one asset until the work site and/or asset is in an acceptable condition.

Once all necessary tasks are complete regarding steps 542 and 543, the method progresses to a step 546 where the technician 802 utilizes the camera feature of the user device 104, 106 to take at least one “after” photographic image of the work site and/or any corresponding assets thereat to document the current condition or state of the work site and/or assets thereat. The step 546 further includes the technician 802 uploading the image to the application 132 to be associated with the corresponding work order case, and to hence be accessible when accessing the corresponding work order case. The step 546 may be initiated by the selection of a graphic interactive area displayed on the user device 104, 106 indicating that the technician 802 is ready to photograph the work site and/or assets when the technician 802 is accessing the work order case during the completion of the corresponding work order.

When the determination of “no” is made with respect to step 522, the method may include both the need to generate a formal quote according to steps 527-531 to account for the unavailable parts needed to complete the work order and the need for the technician 802 to proceed to a step 545 where the technician 802 repairs, cleans, or otherwise addresses any possible safety hazards at the work site. The step 545 then leads to the step 546, except the image taken in step 546 will only include the condition of the work site being altered by the step 545, and not by the completion of the work order according to steps 542 and 543.

A step 547 includes the technician 802 recording any notes or other documentation regarding the completion of the work order, the work site, and/or the assets thereat via an interaction with the application 132 and during access to the corresponding work order case. The notes created during step 547 may be stored by the computing system 206 as a part of the work order case and may be accessible during access thereto via the application 132.

Once all notes are recorded to the application 132 in step 547, the method progresses to a step 548 where the technician 802 obtains a signature from the customer 600 or an approved representative thereof via use of the application 132 and during access to the corresponding work order case. The signature process may include the entry of the name of the customer 600 or representative thereof and the use of the graphical interface of the user device 104, 106 to generate a digital signature of the customer 600 or representative thereof, such as utilizing a touch screen display to create a finger or stylus generated signature. The signature is accepted and the digital image thereof is communicated to and stored by the computing system 206 to the corresponding work order case to record the approval, by the customer 600 or representative thereof, of the work performed by the technician 802. The digital signature may be accessed during access to the work order case while navigating the application 132.

Once the signature is attained and uploaded via step 548, the method progresses to a step 549 where a determination is made by the technician 802 regarding whether additional work is needed at the corresponding work site or with respect to any assets thereat. The determination at step 548 may be based on the inability to complete the work order for whatever reason, or may be based on the discovery of additional concerns with respect to the work site and/or any assets thereat following the tasks performed by the technician 802 at the work site. The step 549 may include the application 132 prompting the technician 802 to answer such a query following the step 548. As shown in FIG. 2, a determination of “yes” with respect to step 549 indicating the need for additional work causes the method to redirect to the previously disclosed step 527 wherein a formal quote is created by the affiliate 800 to address the additional work needed, and the process then proceeds from step 527 to result in the technician 802 completing the additional work according to the previously described work flow. FIG. 2 also discloses that either of a determination of “yes” or “no” with respect to step 549 also leads to a step 550 where the technician 802 checks out of the work site to confirm completion of the interaction between the technician 802 and the work site with respect to the corresponding work order.

The step 550 may include the technician 802 being prompted to complete entry of a description of the work performed at the work site, to take and/or upload one of the “after” images when the step 546 has not been previously completed, to acquire the signature of the customer 600 when the step 548 has not been previously completed, and/or to determine if additional work is needed when the step 549 has not been previously completed. Completion of the step 550 accordingly requires the technician 802 to successfully complete each of steps 546-549 to check-out of the work site and complete the work order. Each of the processes required to complete the check-out process in step 550 may be accomplished via use of the application 132 during access to the corresponding work order case, and the corresponding data and/or files relating to such processes may be associated with the corresponding work order case. Once the technician 802 is checked-out, the administrator 801 generates an invoice in a step 551 and then submits the invoice in a step 552.

The check-out process may include the computing system 206 making a determination that the technician 802 is checked-out only when one or more specified check-out conditions is determined to be satisfied by the computing system 206. As described above, each of the check-out conditions may include the user device 104, 106 of the technician 802 sending a communication to the computing system 206 including data related to a status update of the work site, work order, or associated assets, such as an “after” photo, a digital signature, or a request for a formal quote to perform additional work during a second engagement of the technician 802 with the work site.

In some embodiments, the steps 551 and 552 may be achieved via utilization of the application 132 and the use of appropriate templates for populating all necessary fields in generating a corresponding invoice. In other embodiments, the invoice may be generated independently of the application 132, and the invoice may include the use of a printed hardcopy version of the invoice that may be imaged by the user device 104, 106 via the camera feature thereof and then may be uploaded to the corresponding work order case. The details of the invoice and/or the image of the invoice may be associated with the work order case of the associated work order being invoiced.

In some embodiments, the method according to the flow chart 1000 may further include a step (not shown) wherein the technician 802 must submit at least one form or document that is specific to the customer 600 or otherwise specific to the type of work being performed by the technician 802 or the type of asset being serviced by the technician 802. All such forms may be associated with the corresponding work order case and may be accessible during use of the application 132. The technician 802 may print out hardcopy versions of such forms or documents to be filled out and/or signed by hand, as such forms or documents may not be in a form for digital data entry. Such a form or document may be required to be submitted as a condition of the step 550 to complete the check-out process. The submission of the form or document may include the use of the camera feature of the user device 104, 106, as accessed during use of the application 132, for taking photographic images of each necessary form or document. The application 132 may be configured to alert the technician 802 when any of the customer specific forms or documents have not been submitted when the technician 802 attempts to check-out, or when any of the processes associated with completing step 550 have not been completed.

The present method discloses several instances wherein the user device 104, 106 of the administrator 801 and/or the technician 802 receives a communication, notification, prompt, or message relating to the occurrence of certain actions, such as certain actions taken by the enterprise system 200 in response to a request from one of the affiliates 800. Each such communication to the administrator 801 and/or the technician 802 may be sent as a push-notification automatically causing the user device 104, 106 receiving the notification to actively communicate the reception of the notification to the corresponding administrator 801 and/or technician 802. The push-notification may include an audible sound and/or tactile vibration of the corresponding user device 104, 106, and/or the generation of a graphical alert or similar indicator that is automatically displayed on the graphical interface of the user device 104, 106 upon receipt of the notification. The use of an active alert method aids in ensuring that the work flow of the method is carried out efficiently by continuous updating the affiliate 800 of actions occurring outside of the control of the affiliate 800. Non-limiting examples of situations wherein such a push-notification and alert may be utilized may be when a new work order has been assigned to the affiliate 800 and/or one of the technicians 802 thereof, when a technician 802 has missed a check-in within the established window of time, when a technician 802 has missed a check-out within established window of time, when an expected parts delivery date has passed, or when an updated NTE request has been approved or rejected.

The flow chart 1000 illustrates a work flow with respect to a single work site requiring one or more visits from one of the technicians 802 to complete the associated work order. However, it should be apparent that each affiliate organization 800, and hence each associated administrator 801 and/or technician 802 thereof, may be assigned multiple different work orders associated with multiple different work order cases simultaneously such that each administrator 801 and/or technician 802 must select the corresponding work order case from a list of work order cases that the corresponding administrator 801 and/or technician 802 currently has access to, such as all work order cases associated with any pending, assigned, in-progress, or completed work orders. The application 132 may accordingly include an interface for sorting and/or searching for data related to each work order case or each technician 802 in order to quickly and easily identify and access each work order case during navigation of the application 132.

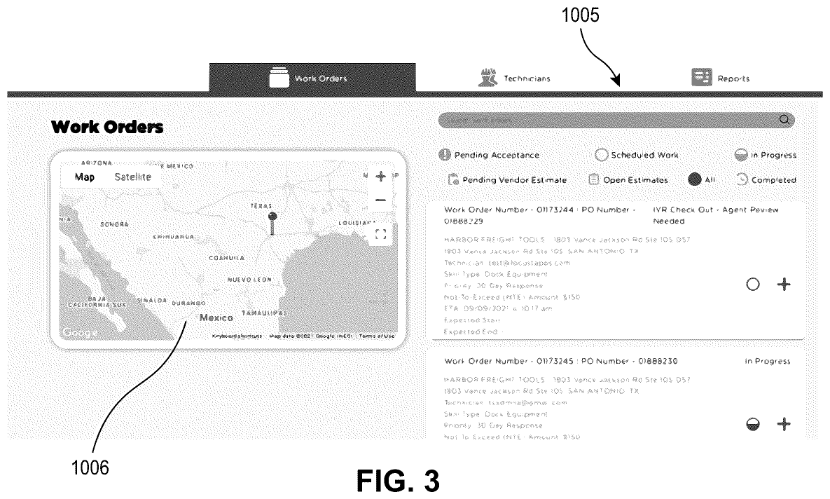

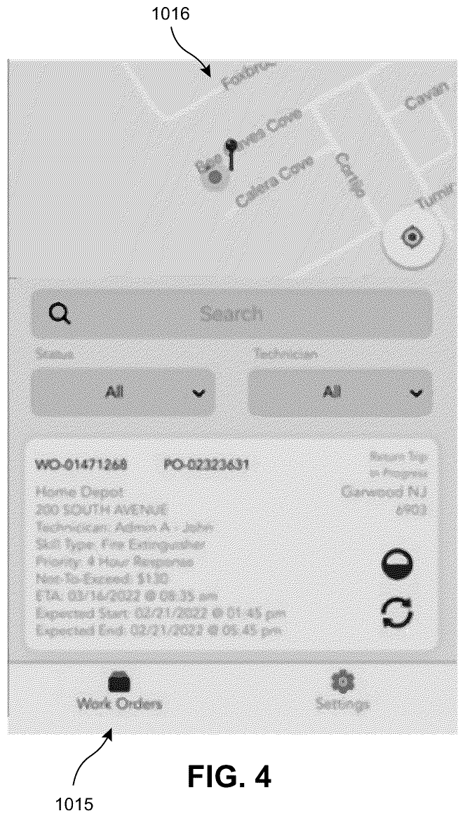

FIGS. 3 and 4 show representative graphical displays as may be presented on a corresponding user device 104, 106 during navigation of the application 132 or a web-based browser equivalent thereof. In FIG. 3, which shows what may be a web-based browser version of the described application 132, the graphical display shows an interface 1005 wherein the technician 802 may organize the work order cases by work order, by assigned technician, or by the reports generated during the carrying out of the work orders. FIG. 4 shows what may be an equivalent mobile device based version of an interface 1015 having a different configuration of data, but the same functionality as the browser based version of the interface 1005 of FIG. 3.

FIG. 3 illustrates a “work orders” tab being selected wherein data regarding each individual work order is sorted by work order number with additional information associated with the corresponding work order case displayed therealong. Each associated work order case may be accessed by interacting with the graphical representation of the work order case during navigation of the interface 1005. Selection of the “technicians” tab may instead sort the work order cases according to which technician 802 is assigned thereto or otherwise associated therewith, whereas the “reports” tab may sort the various different reports generated when servicing the work site according to the present method.

As shown in FIG. 3, the “work orders” tab of the interface 1005 may include the ability to search for terms or to sort the work order results in accordance with various different sort filters. The sort filters are illustrated as sorting the work order cases according to whether the work order case is pending acceptance, scheduled for work, in progress, pending a vendor estimate, associated with an open estimate, or completed, as non-limiting examples. Additional filters may include a filter displaying work order cases having a vendor estimate secured or identifying work orders in need of parts being delivered, as further non-limiting examples. Each work site associated with each work order case may also be displayed on a map 1006 shown as a part of the interface 1005 or a map 1016 shown as a part of the interface 1015.

Each of the disclosed interfaces 1005, 1006 may be utilized by an administrator 801 or a technician 802 of the affiliate 800 when attempting to select a work order case for which the administrator 801 or the technician 802 would like to take action, such as accepting an assignment, starting a job, checking-in, uploading a necessary file or document, etc. The interfaces 1005, 1006 accordingly provide the affiliate 800 the ability to quickly and easily sort all necessary data when prioritizing and scheduling activities related to starting and completing such work orders. The administrator 801 can also sort various work order related data according to each technician 802 of the affiliate 800 in order to better understand and manage the activities of each individual technician 802.

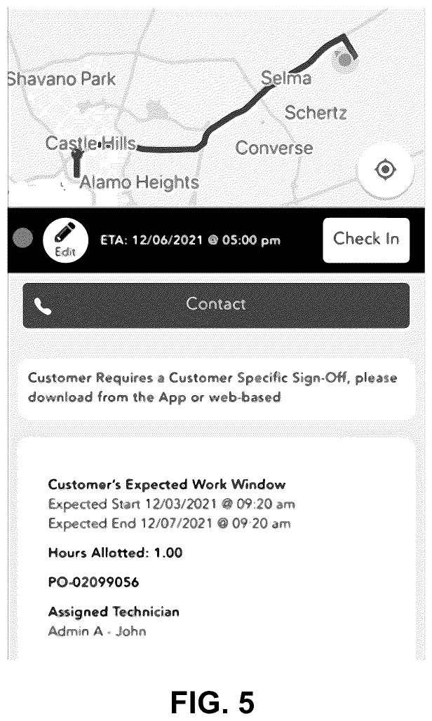

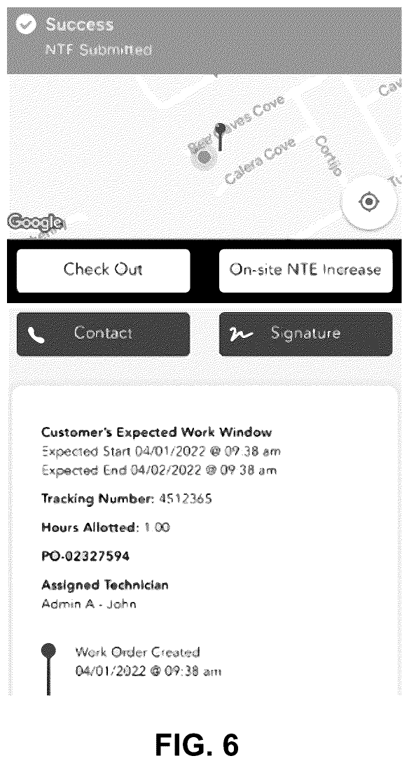

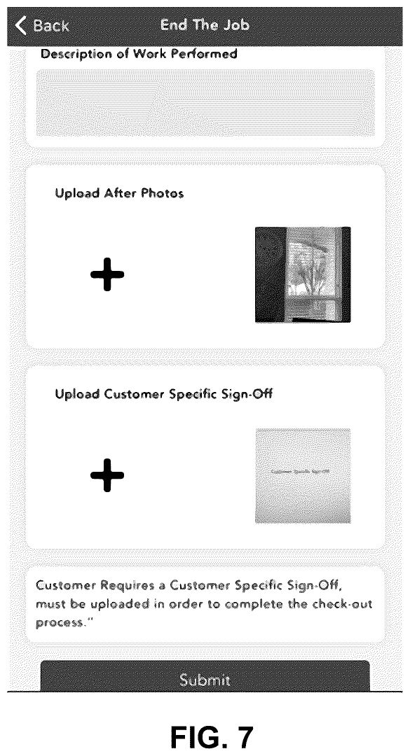

Referring now to FIGS. 5-7, various different exemplary graphical displays as may be seen on the user device 104, 106 during the execution of the application 132 while carrying out the method according to FIG. 2 are disclosed. Each of the disclosed graphical displays corresponds to the selection of and access to a corresponding one of the work order cases, as located during use of one of the interfaces 1005, 1006, that then displays all necessary data and all necessary interactive areas for progressing through the work flow established in FIG. 2. The data displayed and the available interactive areas (buttons, symbols, interactive text, etc.) change as the process of completing the work order progresses to allow for the administrator 801 and/or the technician 802 to have the most up to date information while also having access to the appropriate features based on the known progression of the completion of the work order. For example, FIG. 5 illustrates a work order case that has only recently been started with the graphical display including interactive areas corresponding to such actions as checking-in a technician 802, editing the ETA of the technician 802, or contacting the customer 600. FIG. 6 illustrates a work order case that has progressed such that the interactive areas displayed include selections to start the check-out process, request an on-site NTE increase, or to attain the signature of the customer 600. Lastly, FIG. 7 displays a check-out process wherein interactive areas are provided to initiate the process of taking or uploading a photographic image relating to the work site and/or a customer specific document associated with the work site, as well as to enter notes regarding the work performed at the work site.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A method of executing a work order comprising the steps of:
generating, by a computing system of a first business entity, a work order regarding a task to be performed at a work site with respect to one or more assets disposed thereat;
assigning the work order to a technician, the technician utilizing a first user device executing a software application managed by the computing system;
conducting a check-in process regarding confirming an arrival of the technician and the first user device thereof at or adjacent the work site during a first technician engagement at the work site, the check-in process including the computing system determining whether the technician has satisfied each of one or more check-in conditions, wherein each of the check-in conditions being satisfied includes a check-in communication being sent from the first user device of the technician to the computing system during execution of the software application;
assessing and diagnosing, by the technician, any potential issues or concerns with respect to each of the one or more assets associated with the work order; and
conducting a check-out process regarding the technician completing the task specified by the work order and/or the technician requesting a second technician engagement at the work site, the check-out process including the computing system determining whether the technician has satisfied each of one or more check-out conditions, wherein each of the check-out conditions being satisfied includes a check-out communication being sent from the first user device of the technician to the computing system during execution of the software application.

2. The method of claim 1, wherein one of the check-in communications includes data regarding an instantaneous geographic position of the first user device of the technician.

3. The method of claim 2, wherein the first user device accesses a GPS tracking service thereof when determining the instantaneous geographic position of the first user device of the technician.

4. The method of claim 1, wherein one of the check-in conditions includes the first user device of the technician being disposed within a threshold distance of a geographic position of the work site.

5. The method of claim 3, wherein the threshold distance is 0.2 miles.

6. The method of claim 4, wherein the computing system determines that the check-in condition has been met by comparing an instantaneous GPS position of the first user device of the technician to a known GPS position of the work site stored to a storage device of the computing system.

7. The method of claim 4, wherein the first user device of the technician being disposed within a threshold distance of a geographic position of the work site is the only check-in condition, and wherein the computing system automatically completes the check-in process and updates a status of the technician in reaction to the satisfying of the only check-in condition.

8. The method of claim 1, wherein one of the check-in communications includes data regarding an image of the work site and/or one of the assets disposed thereat.

9. The method of claim 8, wherein the image is taken by the technician using a camera feature of the first user device.

10. The method of claim 1, wherein one of the check-out conditions corresponds to whether the technician has submitted a signature from a representative of a customer associated with the work site.

11. The method of claim 10, wherein the signature is a digital signature and the signature is generated using a graphical interface of the first user device during execution of the software application.

12. The method of claim 1, wherein one of the check-out conditions corresponds to whether the technician has taken and submitted at least one image of the one or more assets associated with the work order.

13. The method of claim 12, wherein the at least one image is taken by the technician using a camera feature of the first user device.

14. The method of claim 1, wherein one of the check-out conditions corresponds to whether the technician has indicated whether a second technician engagement at the work site is necessary to complete the work order.

15. The method of claim 1, further comprising a step of requesting, by the technician, a formal quote to perform additional work or purchase additional parts.

16. The method of claim 15, wherein the requesting step is performed via use of a quote generating feature of the software application.

17. The method of claim 15, wherein the requesting step is performed when the technician determines that the technician cannot complete the work order during the first technician engagement with the work site.

18. The method of claim 15, wherein the requesting step is performed when the technician determines that additional work outside of the scope of the task designated in the work order is necessary.

19. The method of claim 1, wherein the technician is associated with a second business entity contracted by the first business entity to complete the work order.

20. The method of claim 1, wherein the first business entity is responsible for managing the one or more assets disposed at the work site.
